(19) United States
(12) Patent Application Publication
(10) Pub. No.: US 2007/0196133 A1
(43) Pub. Date: Aug. 23, 2007

(54) Image forming apparatus, printed material, and image reading apparatus

(75) Inventor: Shusaku Kubo, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/472,471

(22) Filed: Jun. 22, 2006

(30) Foreign Application Priority Data
Feb. 21, 2006 (JP) P2006-044316

(51) Int. Cl. G03G 15/01

(52) U.S. Cl. 399/223; 399/302

(57) ABSTRACT

An image forming apparatus that includes: a visible image forming unit that forms a visible image on a record material; and a retroreflective image forming unit that forms a retroreflective image having a retroreflection property on the record material.

### CROSS-REFERENCE TO RELATED APPLICATION

This application claims priority under 35 USC 119 from Japanese Patent Application No. 2006-044316, the disclosure of which is incorporated by reference herein.

### BACKGROUND

1. Technical Field

The present invention relates to an image forming apparatus, a printed material, and an image reading apparatus, and more particularly, to a technology for inhibiting an original from being copied.

2. Related Art

Recently, even in a business environment or a home environment, a copy function can be easily realized by a print system combining a copier, a personal computer, a scanner, and a printer. Under such circumferences, a variety of originals (hereinafter, referred to as copy inhibition material), which include important information and must be inhibited from being copied, may be easily copied. In addition, when such a copy inhibition material is illegally copied, the copy inhibition material and the important information recorded on the copy inhibition material may be externally leaked.

### SUMMARY

According to an aspect of the invention, there is provided an image forming apparatus including: a visible image forming unit that forms a visible image on a record material; and a retroreflective image forming unit that forms a retroreflective image having a retroreflection property on the record material.

### BRIEF DESCRIPTION OF THE DRAWINGS

Embodiments of the present invention will be described in detail based on the following figures, wherein:

FIG. 1 is a view showing an overall configuration of a system related to an embodiment of the present invention;

FIG. 2 is a block diagram showing a configuration of an identification information managing server;

FIG. 3 is a view showing contents stored in a correspondence information database;

FIG. 4 is a view showing a configuration of a printer device according to a first embodiment of the present invention;

FIGS. 5A to 5C are explanatory views showing a developer and a toner;

FIG. 6 is a view showing light reflection characteristics of naphthalocyanine and croconium used as an infrared-ray absorbing agent;

FIGS. 7A to 7C are explanatory views showing a two-dimensional code image printed on a medium;

FIG. 8A is a view showing a printed material having a visible image, an invisible image, a copy inhibition image and FIG. 8B is a view showing a printed material having only a visible image;

FIG. 9 is a view showing a configuration of a scanner device in an image forming apparatus;

FIG. 10 is a view showing a schematic configuration of a CCD image sensor provided in the scanner device;

FIGS. 11A and 11B are explanatory views showing irradiation of light onto a general original and reflection of the light from the original;

FIGS. 12A and 12B are explanatory views showing irradiation of light onto an original having a copy inhibition image and reflection of the light from the original;

FIG. 13 is an explanatory view showing retroreflection due to a retroreflective material;

FIG. 14A is a view showing a copied material obtained by scanning a printed material having a visible image, an invisible image, and a copy inhibition image, and FIG. 14B is a view showing a copied material obtained by scanning a printed material having only a visible image;

FIG. 15 is a view showing a configuration of the image forming apparatus related to operations from when scanning the printed material to when printing out the contents of the visible image formed on the printed material as the copied material;

FIG. 16 is a flowchart explaining an operation of obtaining the copied material obtained by copying the visible image of the printed material;

FIG. 17 is a table showing the sequence of forming a visible toner layer, an invisible toner layer, and a retroreflective toner layer on a sheet of paper P, and features and advantages thereof;

FIGS. 18A and 18B show another example of forming a copy inhibition image (retroreflective image);

FIG. 19 is a view showing a configuration of a printer device according to a second embodiment of the present invention; and

FIG. 20A shows a printed material output using the printer device and FIG. 20B shows read data of a visible image obtained by scanning the printed material.

### DETAILED DESCRIPTION

Conventionally, a variety of techniques of preventing or restricting an optional or arbitrary copy inhibition operation on the copy inhibition material to a predetermined range has been suggested. As a method of realizing such a copy inhibition function, there are conventionally five methods as follows.

(1) When an image which is a copy inhibition material is output, specific image information is embedded in a print image, and, when the image is read and the image information is detected, a copy operation is inhibited.

(2) Print image information of a copy inhibition material is previously registered, patterns of read image information obtained by reading an image and the print image information are compared with each other, and a copy operation is inhibited when the patterns are the same.

(3) When a copy inhibition material is output, an object having a property which can be detected by a sensor is attached or included in a medium on which an image is printed, and, when the image is read and the object is detected, a copy operation is inhibited,

(4) A watermark is formed on a medium on which an image is printed or a name of a printing person, etc. is printed to check copy of a copy inhibition material.

(5) When a copy inhibition material is output, a code image is recorded on a medium, on which an image is printed, together with the image, using a material having an absorption property only in an infrared area, and the code image cannot be applied to a copied material such that the code image cannot be read when the image is read.

However, in the techniques (1) to (3), the copy inhibition material may be copied when a detecting unit is not provided at a reading side. In addition, in the technique (2), since the print image information of the copy inhibition material should be stored in a memory, a large amount of memory capacity is needed and a time required for comparing the patterns with each other increases. Furthermore, in the technique (3), a special medium is required.

In the technique (4), since the watermark or the name of the printing person should be printed on the medium configuring the copy inhibition material, the image is inferior in appearance. In addition, in the technique (4), since the copy of the copy inhibition material is only checked, it is impossible to inhibit the copy inhibition material from being copied using a copier.

In the technique (5), it can be determined whether the material is the original or not by existence of the code image, but the image other than the code image is copied. That is, even in this case, it is impossible to inhibit the copy inhibition material from being copied using a copier.

Hereinafter, embodiments of the present invention will be described in detail with reference to the attached drawings.

### First Embodiment

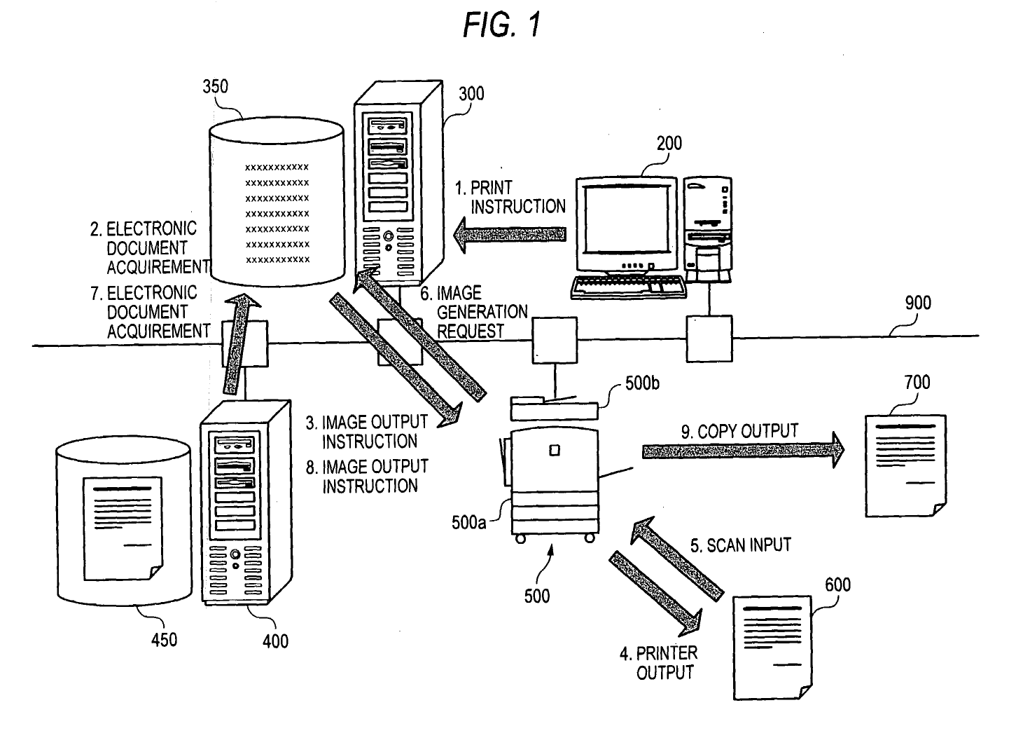

FIG. 1 is a view showing an example of a configuration of a system related to an embodiment of the present invention. The system includes a terminal apparatus 200, an identification information managing server 300, a document managing server 400, an image forming apparatus 500, and a network 900. The terminal apparatus 200 instructs an electronic document to be printed. The identification information managing server 300 manages identification information applied to a sheet of paper (medium) when the electronic document is printed and generates an image in which a code image including the identification information or the like and the image of the electronic document overlap each other. The document managing server 400 manages the electronic document. The image forming apparatus 500 has a printer device 500a and a scanner device 500b, prints the image, in which the code image and the image of the electronic document overlap each other, using the printer device 500a and reads the image on the medium using the scanner device 500b. The network 900 connects the terminal apparatus 200, the identification information managing server 300, the document managing server 400, and the image forming apparatus 500 (the printer device 500a and the scanner device 500b) to one another over a communication line.

In addition, an identification information repository 350 for storing the identification information is connected to the identification information managing server 300 and a document repository 450 for storing the electronic document is connected to the document managing server 400.

The system further includes a printed material output by the printer device 500a of the image forming apparatus 500 by the instruction of the terminal apparatus 200 and a copied material 700 obtained by scanning the printed material 600 by the scanner device 500b of the image forming apparatus 500 and outputting the scanned printed material by the printer device 500a.

Hereinafter, an operation of the system will be schematically described.

First, the terminal apparatus 200 instructs the identification information managing server 300 to print the electronic document managed by the document repository 450 while overlapping the code image (1). At this time, a sheet size, a direction, reduction/enlargement, N-Up printing (printing in which n pages of electronic documents are assigned to a piece of paper), and print attribute such as double-sided print are input from the terminal apparatus 200.

The identification information managing server 300 acquires the electronic document to be printed from the document managing server 400 (2). The identification information managing server 300 applies the identification information managed by the identification information repository 350 and the code image including position information determined according to the print attribute to the image of the acquired electronic document and instructs the image forming apparatus 500 to print the electronic document (3). In addition, the identification information is to identify the medium (sheet) on which the image of the electronic document is printed and the position information is to specify a coordinate position (X coordinate and Y coordinate) on the medium.

Thereafter, the printer device 500a of the image forming apparatus 500 outputs the printed material 600 according to the instruction of the identification information managing server 300 (4). In addition, as described below in detail, the printer device 500a of the image forming apparatus 500 forms the code image applied by the identification information managing server 300 as an invisible image using an invisible toner and forms the other image (the image included in the original electronic document) as a visible image using a visible toner. Furthermore, in the present embodiment, the printer device 500a further forms a copy inhibition image for inhibiting the output visible image from being copied, in addition to the invisible image and the visible image.

Meanwhile, the output printed material 600 is scanned by the scanner device 500b of the image forming apparatus 500 (5). At this time, the scanner device 500b cannot read the visible image by the above-described copy inhibition image. The scanner device 500b can read the invisible image, as described below. At the time of scanning the printed material 600, when a personal authentication is performed using an IC card, the scanner device 500b of the image forming apparatus 500 analyzes the code image based on the read invisible image and transmits to the identification information managing server 300 an image generating request for applying the code image to the electronic document corresponding to the printed material 600 and the image of the electronic document together with authentication information (6).

The identification information managing server 300 acquires the electronic document corresponding to the printed material 600 from the document managing server 400 (7). In addition, the identification information managing server 300 determines whether a user (a person having the personal authentication) who tires to output the electronic document based on the authentication information has an operation authority (copy authority) for copying the electronic document or not. Furthermore, when it is determined that the user has the copy authority for the electronic document, the identification information managing server 300 applies the identification information managed by the identification information repository 350 and the code image including the position information determined according to the print attribute to the acquired electronic document and instructs the image forming apparatus 500 to print the electronic document (8).

Thereafter, the image forming apparatus 500 outputs the copied material 700 having the visible image having the same contents as the printed material 600 according to the instruction of the identification information managing server 300 (9).

However, such a configuration is only exemplary, and, for example, one sever may have the function of the identification information managing server 300 and the function of the document managing server 400 or an image processing unit of the image forming apparatus 500 may have the function of the identification information managing server 300. In addition, in the present embodiment, the electronic document may, for example, be a document including only text data, a document including text data and image data such as a picture, or a document including only image data.

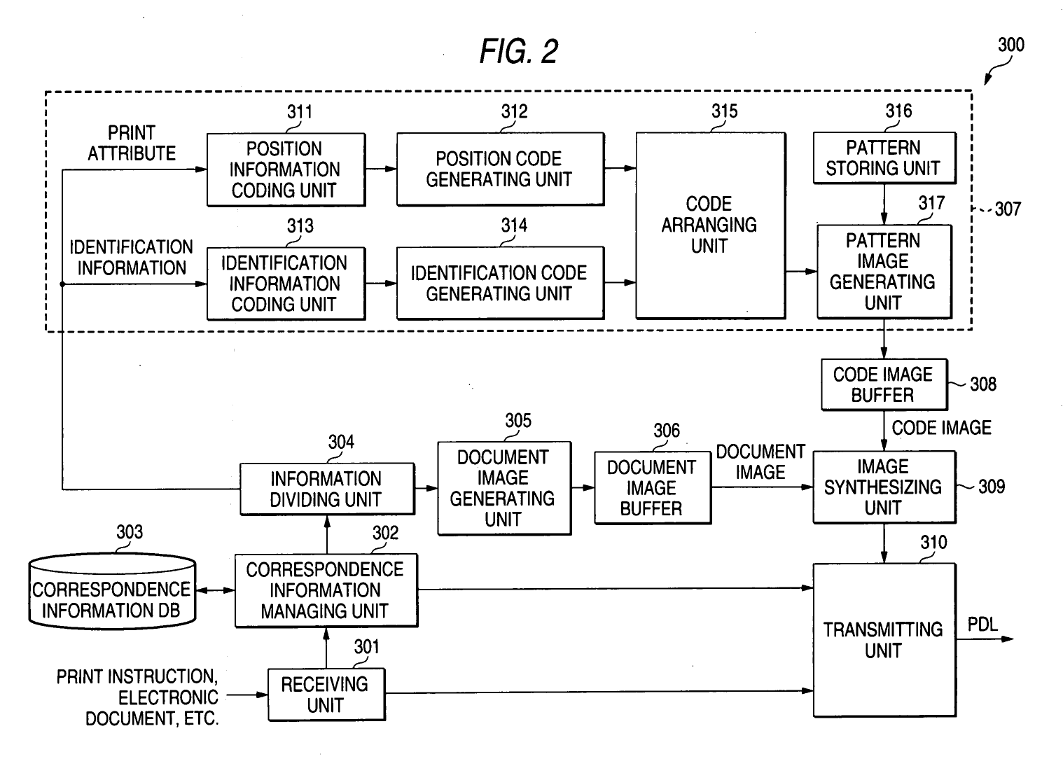

Next, the configuration and the operation of the system will be described in detail. FIG. 2 is a view showing a configuration of the identification information managing server 300.

The identification information managing server 300 includes a receiving unit 301, a correspondence information managing unit 302, a correspondence information database (DB) 303, an information dividing unit 304, and a document image generating unit 305. The identification information managing server 300 further includes a document image buffer 306, a code image generating unit 307, a code image buffer 308, an image synthesizing unit 309, and a transmitting unit 310.

In addition, the code image generating unit 307 includes a position information coding unit 311, a position code generating unit 312, an identification information coding unit 313, an identification code generating unit 314, a code arranging unit 315, a pattern storing unit 316, and a pattern image generating unit 317.

Among them, the receiving unit 301 receives a variety of information such as the print instruction and the electronic document to be printed over the network 900 (see FIG. 1).

The correspondence information managing unit 302 registers the information to the correspondence information DB 303 and reads the information from the correspondence information DB 303.

In addition, at the time of copying the printed material 600 described below, the receiving unit 301 receives (acquires) the identification information obtained from the printed material 600 and the correspondence information managing unit 302 specifies the electronic document corresponding to the identification information with reference to the correspondence information DB 303.

The correspondence information DB 303 stores correspondences such as the identification information for identifying the medium, a storage position of the electronic document to be printed on the medium, and the personal copy authority for the electronic document.

The information dividing unit 304 divides the information received from the correspondence information managing unit 302 into information necessary for generating a document image and information necessary for generating the code image.

The document image generating unit 305 converts the electronic document into the document image based on the information necessary for generating the document image divided by the information dividing unit 304 and stores the document image in the document image buffer 306.

The code image generating unit 307 generates the code image based on the information necessary for generating the code image divided by the information dividing unit 304 and stores the code image in the code image buffer 308.

The image synthesizing unit 309 synthesizes the document image stored in the document image buffer 306 with the code image stored in the code image buffer 308.

The transmitting unit 310 transmits the instruction for outputting the image synthesized by the image synthesizing unit 309 to the printer device 500a of the image forming apparatus 500 (see FIG. 1) as a page description language (PDL) representative of postscript.

In addition, in the code image generating unit 307, the position information coding unit 311 codes the position information using a predetermined coding method. The coding can, for example, use a BCH code or a Reed Solomon (RS) code, which is already known as an error correcting code. In addition, a cyclic redundancy check (CRC) or checksum value of the position information may be calculated using an error detecting code and added to the position information as a redundancy bit. Furthermore, an M-series code of pseudo-noise series maybe used as the position information. The M-series code is coded using a property that, when partial series having a length P are extracted from a P-th order X series (the length of the series is 2^{P-1}), a bit pattern, which appears in the partial series, appears only once in the M series.

The position code generating unit 312 converts the position information coded by the position information coding unit 311 into the code information which is embedded. For example, the bits of the coded position information may be rearranged or encrypted using pseudorandom numbers such that a thirty cannot perform decryption. In addition, when the position codes are arranged in two dimensions, the bit values are arranged in two dimensions, similar to the arrangement of the code.

In addition, in the present embodiment, the position information coding unit 311 selects the position information coded according to the print attribute received from the information dividing unit 304 from the coded position information which is previously generated and stored every print attribute. This is because the position code printed on the sheet can be specified to one when the sheet size, the direction, enlargement/reduction, and the N-up printing are determined.

Meanwhile, when the print attribute is always the same, the position code printed on the sheet is always the same. Accordingly, when the print is only performed in the same print attribute, the position information coding unit 311 and the position code generating unit 312 may be coupled to a position code storing unit for storing a set of position codes such that the position code is always used.

In addition, when the identification information is input, the identification information coding unit 313 codes the identification code using the predetermined coding method. The coding may be performed using the same method as the method of coding the position information.

The identification code generating unit 314 converts the identification information coded by the identification information coding unit 313 into the code information which is embedded. For example, the bits of the coded identification information may be rearranged or encrypted using pseudorandom numbers such that a thirty cannot perform decryption. In addition, when the identification codes are arranged in two dimensions, the bit values are arranged in two dimensions, similar to the arrangement of the code.

The code arranging unit 315 synthesizes the coded position information and the coded identification information, both of which are arranged in the same manner as the code, and generates two-dimensional code array corresponding to an output image size. At this time, as the coded position information, a code obtained by coding the position information which varies depending on an arrangement position is used, and, as the coded identification information, a code obtained by coding the same information independent of the position is used.

The pattern image generating unit 317 checks the bit values of the elements of the two-dimensional code array, acquires bit pattern images corresponding to the respective bit values from the pattern storing unit 316, and outputs the two-dimensional code array as the code image.

In addition, such functions are realized by cooperation of software and hardware. Specially, a central processing unit (CPU; not shown) of the identification information managing server 300 reads a program for embodying the functions of the receiving unit 301, the correspondence information managing unit 302, the information dividing unit 304, the document image generating unit 305, the code image generating unit 307, the image synthesizing unit 309, and the transmitting unit 310 from an external storage to a main storage and performs the functions.

Next, an operation performed when the identification information managing server 300 instructs the image forming apparatus 500 (printer device 500a) to print an image according to the instruction of the terminal apparatus 200 will be described.

In the identification information managing server 300, first, the receiving unit 301 receives the print instruction including the storage position and the print attribute of the electronic document to be printed from the terminal apparatus 200. Among the received information, the print attribute is sent to and held in the correspondence information managing unit 302. In addition, the storage position of the electronic document is sent to the transmitting unit 310 such that the transmitting unit 310 transmits a request for acquiring the electronic document to be printed from the storage position to the document managing server 400 (see FIG. 1).

Accordingly, the document managing server 400 transmits the electronic document to be printed to the identification information managing server 300 and the identification information managing server 300 receives the electronic document and sends the electronic document to the correspondence information managing unit 302. The correspondence information managing unit 302 extracts the identification information from the identification information repository 350 (see FIG. 1) and registers the correspondence between the identification information and the storage position of the electronic document in the correspondence information DB 303. In addition, by specifying a specific position of the electronic document to be printed, the correspondence with a storage position of an electronic document to be referenced is also registered in the correspondence information DB 303.

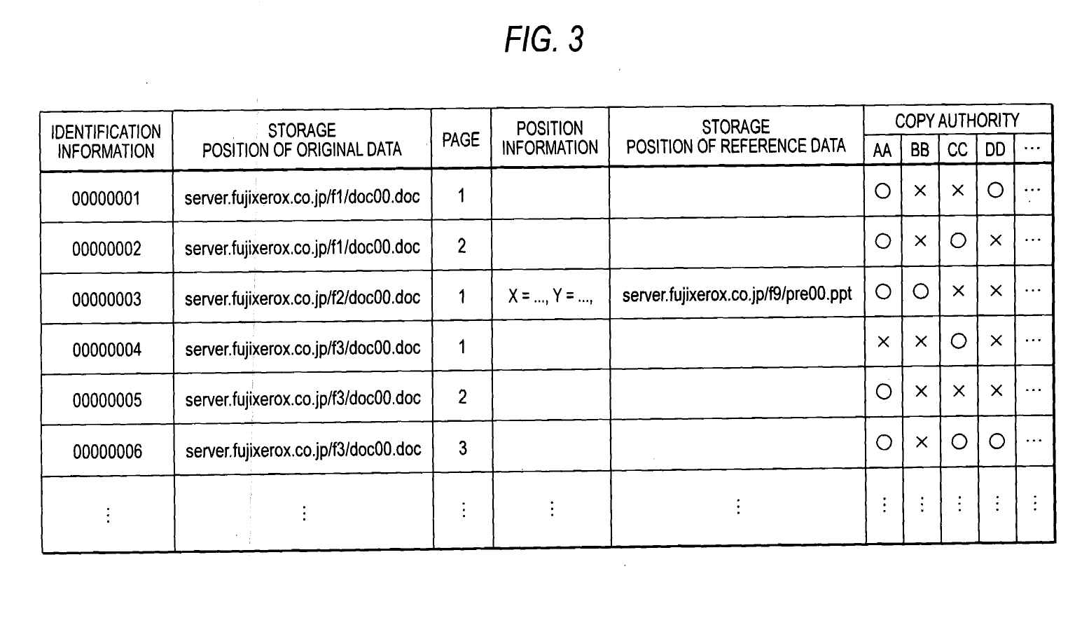

Now, the contents in the correspondence information DB 303 will be described with reference to FIG. 3.

As shown, the correspondence information DB 303 includes at least one of the identification information, the storage position of the electronic document (original data) to be printed, a page number of the original data, the electronic document (reference data) to be referenced by specifying the position information, and the existence of the personal copy authority for the electronic document.

For example, the identification information “00000001” is assigned to page 1 of the original data “doc00.doc” under “server.fujixerox.co.jp/f1” and the identification information “00000002” is assigned to page 2 of the same original data.

In addition, the original data “doc00.doc” under “server.fujixerox.co.jp/f2” is composed of only one page, but can access the reference data “pre00.ppt” under “server.fujixerox.co.jp/f9” when the specific position is specified. In addition, as an example of such a document, “doc00.doc” maybe a conferencing notification and “pre00.ppt” may be a presentation material used for the conference.

In addition, the identification information employs a serial number. However, when the identification information is generated by combining an image forming date and the identification information of the image forming apparatus 500, an output history can be recorded on the medium by updating the identification information using the below-described process.

Among the contents of the correspondence information DS 303, the information on the personal copy authority for the electronic document may be registered later. Furthermore, the information on the personal copy authority for the electronic document is used for copying the electronic document as described below. The detailed description will be provided later.

When the information is registered in the correspondence information DB 303, the correspondence information managing unit 302 sends the electronic document, the identification information, and the held print attribute to the information dividing unit 304.

The information dividing unit 304 divides the received information into the information necessary for generating the code and the information necessary for generating the document image and outputs the former to the code image generating unit 307 and the latter to the document image generating unit 305.

To this end, in the code image generating unit 307, the position information coding unit 311 codes the position information corresponding to the print attribute and the position code generating unit 312 generates the position code representing the coded position information. In addition, the identification information coding unit 313 codes the identification information and the identification code generating unit 314 generates the identification code representing the coded identification information.

Furthermore, the code arranging unit 315 generates the two-dimensional code array corresponding to the output image size and the pattern image generating unit 317 generates the pattern image corresponding to the two-dimensional code array.

Meanwhile, the document image generating unit 305 generates the document image of the electronic document. In addition, the image synthesizing unit 309 synthesizes the document image generated by the document image generating unit 305 with the code image generated by the code image generating unit 307 and sends the synthesized image to the transmitting unit 310. Then, the transmitting unit 310 transmits the output instruction of the synthesized image to the image forming apparatus 500 (printer device 500a).

The printer device 500a prints on the medium (sheet) the image in which the synthesized image having the document image of the electronic document to be printed and the code image overlaps with the below-described copy inhibition image such that the user obtains the printed material 600.

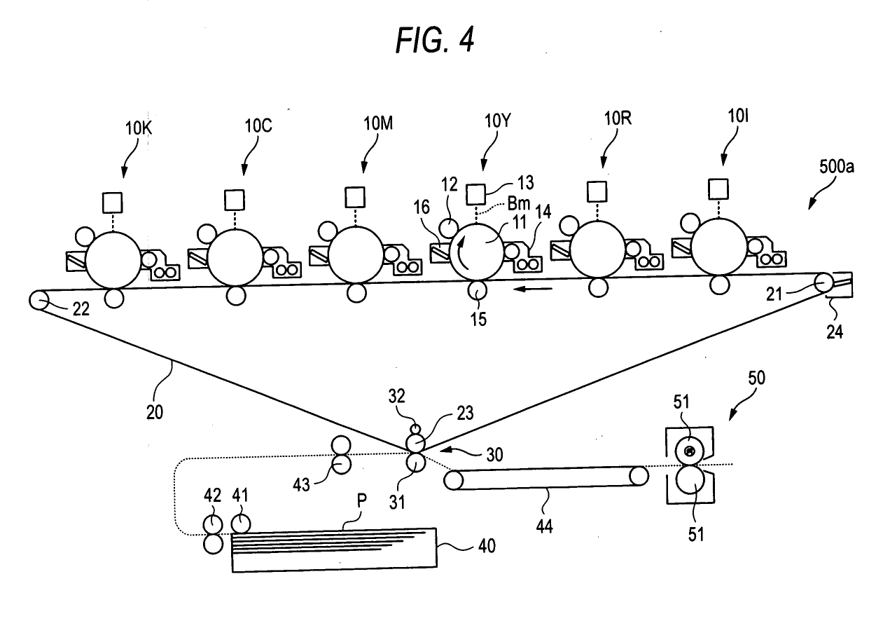

FIG. 4 is a view showing a configuration of the printer device 500a of the image forming apparatus 500. The printer device 500a is a so-called tandem type or intermediate transfer type image forming device. The printer device 500a, for example, includes a plurality (six in the present embodiment) of imaging units 10 (10T, 10R, 10Y, 10M, 10C, and 10K) for forming respective chromatic toner images. The printer device 500a further includes an intermediate transfer belt 20 for sequentially transferring (primarily transferring) the chromatic toner images formed by the respective image forming units 10. The printer device 500a further includes a secondary transferring unit 30 for collectively transferring (secondary transferring) the overlapped image transferred onto the intermediate transfer belt 20 onto a sheet of paper P as a recoding material. The printer device 500a further includes a fixing unit 50 for fixing the secondarily transferred toner image on the sheet P with heat and pressure.

The printer device 500a includes a yellow unit 10Y, a magenta unit 10M, a cyan unit 10C, and a black unit 10K as visible forming units for forming yellow (Y), magenta (M), cyan (C), and black (K) toner images, all of which are visible images having commercially available colors. The printer device 500a further includes an invisible unit 10I as an invisible forming unit for forming the code image, that is, an invisible image, and a retroreflective unit 10R as a retroreflective image forming unit for forming a toner image for copy inhibition, that is, the copy inhibition image (retroreflective image), using a retroreflective material. In addition, the toners used for the imaging units 10 will be described in detail later.

The imaging units 10 (10I, 10R, 10Y, 10M, 10C, and 10K), which function as an image forming unit, have the same configuration except the toner. Accordingly, for example, the yellow unit 10Y will be described. The yellow unit 10Y includes a photosensitive drum 11 which is rotatably arranged in an arrow direction. A charger 12, an exposing unit 13, a developing unit 14, a primary transfer roller 15, and a drum cleaner 16 are arranged in the vicinity of the photosensitive drum 11. Among them, the charger 12 charges the photosensitive drum 11 to a predetermined potential. The exposing unit 13 selectively irradiates laser beam Bm onto the photosensitive drum 11 charged with the predetermined potential by the charger 12 to form an electrostatic latent image on the photosensitive drum 11. The developing unit 14 contains a toner (yellow toner in the yellow unit 10Y) and develops the electrostatic latent image on the photosensitive drum 11 by the toner. In addition, in the present embodiment, as described below, the development is performed using a so-called two-component development using a developer including the toner and a carrier. The primary transfer roller 15 primarily transfers the toner image formed on the photosensitive drum 11 onto the intermediate transfer belt 20 by an applied primary transfer bias. The drum cleaner 16 removes a remaining material (toner, etc.) on the photosensitive drum 11 after the primary transfer. In the present embodiment, the imaging units 10 are arranged in the order of the invisible unit 10I, the retroreflective unit 10R, the yellow unit 10Y, the magenta unit 10M, the cyan unit 10C, and the black unit 10K from an upstream side of a movement direction of the intermediate transfer belt 20.

The intermediate transfer belt 20 is rotatably stretched over a plurality (three in the present embodiment) of support rollers and rotated in the arrow direction. Among the support rollers, a driving roller 21 stretches the intermediate transfer belt 20 and drives and rotates the intermediate transfer belt 20. A driven roller 22 stretches the intermediate transfer belt 20 and rotates by the intermediate transfer belt 20 driven by the driving roller 21. A backup roller 23 stretches the intermediate transfer belt 20 and functions as a member for configuring the secondary transfer unit 30.

In addition, a belt cleaner 24 for removing a remaining material (toner, etc.) on the intermediate transfer belt 20 after the secondary transfer is provided at a position facing the driving roller 21 across the intermediate transfer belt 20.

The secondary transfer unit 30 includes a secondary transfer roller 31 which is in contact with a toner image carrying surface of the intermediate transfer belt 20 and the backup roller 23 which is provided on the rear surface of the intermediate transfer belt 20 and forms an electrode facing the secondary transfer roller 31. A power feeding roller 32 for applying a secondary transfer bias having the same polarity as the charging polarity of the toner is in contact with the backup roller 23. The secondary transfer roller 31 is grounded.

In addition, a sheet carrying system, which is the carrying unit, includes a sheet tray 40, a nudger roller 41, a handle mechanism 42, a registration roller 43, and a carrying belt 44. In the sheet carrying system, the sheet P loaded in the sheet tray 40 is fed out by the nudger roller 41 and carried by the handle mechanism 42 (a feed roller and a retard roller in the present embodiment) one sheet by one sheet. Next, the carried sheet P is temporarily stopped by the registration roller 43 and sent to the secondary transfer position of the secondary transfer unit 30 at a predetermined timing. The sheet P after the secondary transfer is carried to the fixing unit 50 through the carrying belt 44.

In addition, the fixing unit 50 includes a rotatable heat roller 51 having a heating source (for example, a halogen lamp; not shown), and a pressure applying belt 52 which is rotatably in contact with the heating roller 51 and forms a nip portion, through which the sheet P passes, together with the heating roller 51.

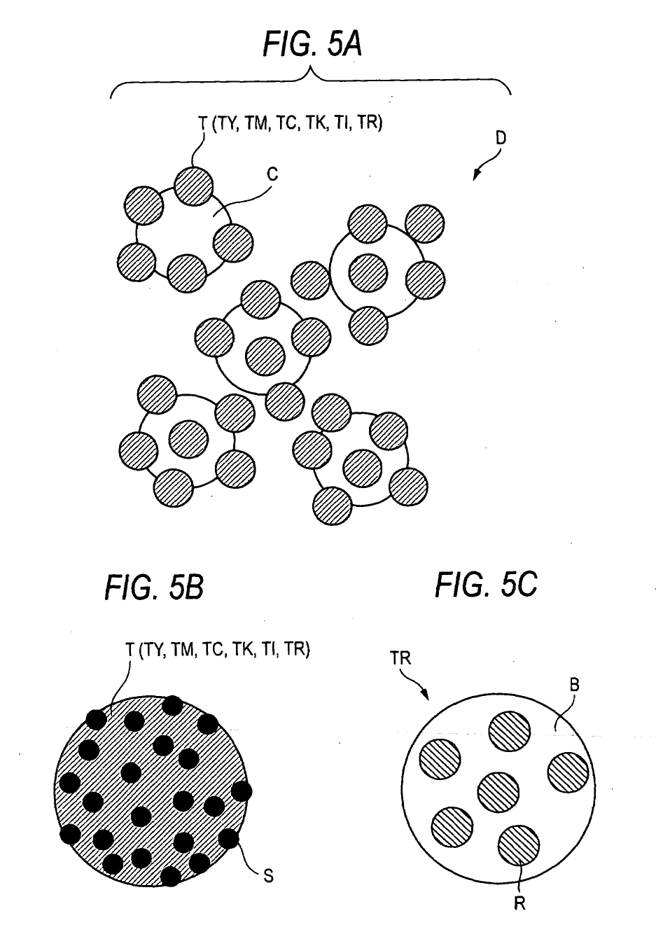

Next, the developer including the toner as an image forming material used for the imaging units 10 (10I, 10R, 10Y, 10M, 10C, and 10K) will be described in detail with reference to FIG. 5A.

As shown in FIG. 5A, the developer D includes a carrier C having a positive charging polarity and magnetism and the toner T (yellow, magenta, cyan, black, invisible property, or retroreflective property). As shown in FIG. 5B, the developer D further includes an external additive agent S. The external additive agent S is attached to the surface of the toner T. In the below description, the respective toners T are called yellow toner TY, magenta toner TM, cyan toner TC, black toner TK, invisible toner TI, or retroreflective toner TR, if necessary.

In the developer D, for example, ferrite bead may be used as the carrier C. In addition, in the developer D, for example, inorganic particles such as silica (SiO₂), titania (TiO₂), or ceria (CeO₂) may be used as the external additive agent S.

In the developer D, each of the toners T (yellow toner TY, magenta toner TM, cyan toner TC, black toner TK, invisible toner TI, or retroreflective toner TR) has a negative charging polarity and is manufactured by a suspension polymerization method, an emulsion/aggregation/coalescing method, or a fusion suspension method. Among them, the yellow toner TY, the magenta toner TM, the cyan toner TC, and the black toner TK used for forming the visible image are formed by including a coloring agent (pigment) in an emulsion polymerization resin (hereinafter, referred to as binder), which is transparent and colorless from a visible area (400 nm to 800 nm) to a near infrared area (800 nm to 1000 nm), as a color material.

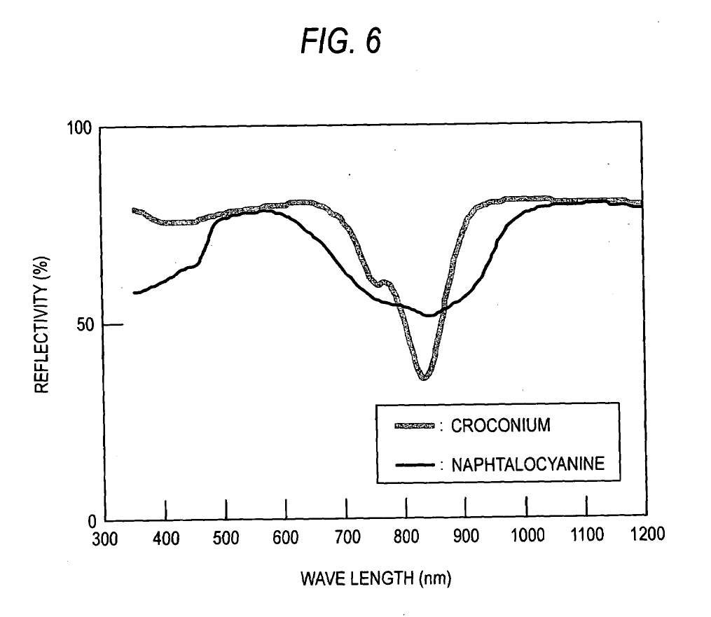

In addition, the invisible toner Ti used for forming the invisible image is formed by including in the binder an infrared absorbing agent having a maximum light absorbing ratio of, for example, 7% or less in the visible area and a light absorbing ratio of, for example, 30% or more in the near infrared area. The infrared absorbing agent, for example, includes Cu—P containing glass frit obtained by containing copper and phosphor in silica glass, ytterbium oxide (Yb₂O₃), naphthalocyanine such as vanadylnaphthalocyanine, or croconium. FIG. 6 shows light reflection characteristics of naphthalocyanine and croconium among the infrared absorbing agent. In FIG. 6, a horizontal axis denotes a light wavelength (nm) and a vertical axis denotes reflectivity (%). As can be seen from FIG. 6, these materials have lower reflectivity in the near infrared area than the visible area, that is, a larger light absorption ratio in the near infrared area than the visible area. The invisible toner TI has an average dispersion diameter of 100 nm to 600 nm in order to increase near infrared light absorbing ability necessary for machine-reading the image using the scanner device 500b. Here, the “visible” and “invisible” does not depend on whether the image is recognized by eye. The “visible” and “invisible” are distinguished from each other depending on whether image printed (formed) on the medium (sheet) can be recognized by a chromatic property due to absorption in a specific wavelength in the visible area.

In addition, the retroreflective toner TR used for forming the toner image for copy inhibition is formed by including a retroreflective material R in a binder B, as shown in FIG. 5C. In the present embodiment, as the retroreflective material R, for example, a spherical glass bead is used. In this case, as the glass for forming the glass bead, silica glass, borosilicate glass, or soda lime glass maybe used. In addition, as the retroreflective toner R, for example, spherical polystyrene may be used. The retroreflective material R has an important property which is not molten at the time of applying heat and pressure using the fixing unit 50. Furthermore, the retroreflective material R of the present embodiment has a retroreflective property with respect to the light in the visible area (400 nm to 800 nm). In contrast, the retroreflective material R does not have the retroreflective property with respect to the light in the near infrared area (800 nm to 1000 nm). The wavelength selectivity of the retroreflective property can be, for example, controlled by an refractive index or a partial diameter of the retroreflective material R.

In addition, the retroreflective material R is different from the external additive agent S attached to the outer circumferential surface of the toner T in that the retroreflective material R is included in the binder B of the retroreflective toner TR. In the present embodiment, the other toners T (the yellow toner TY, the magenta toner TM, the cyan toner TC, the black toner TK, and the invisible toner TI) do not include the retroreflective material R. In addition, as the toners T (the yellow toner TY, the magenta toner TM, the cyan toner TC, the black toner TK, the invisible toner TI, and the retroreflective toner TR), a so-called pulverized toner formed by pulverizing a mass of toner made of a toner material and classifying the toner may be used.

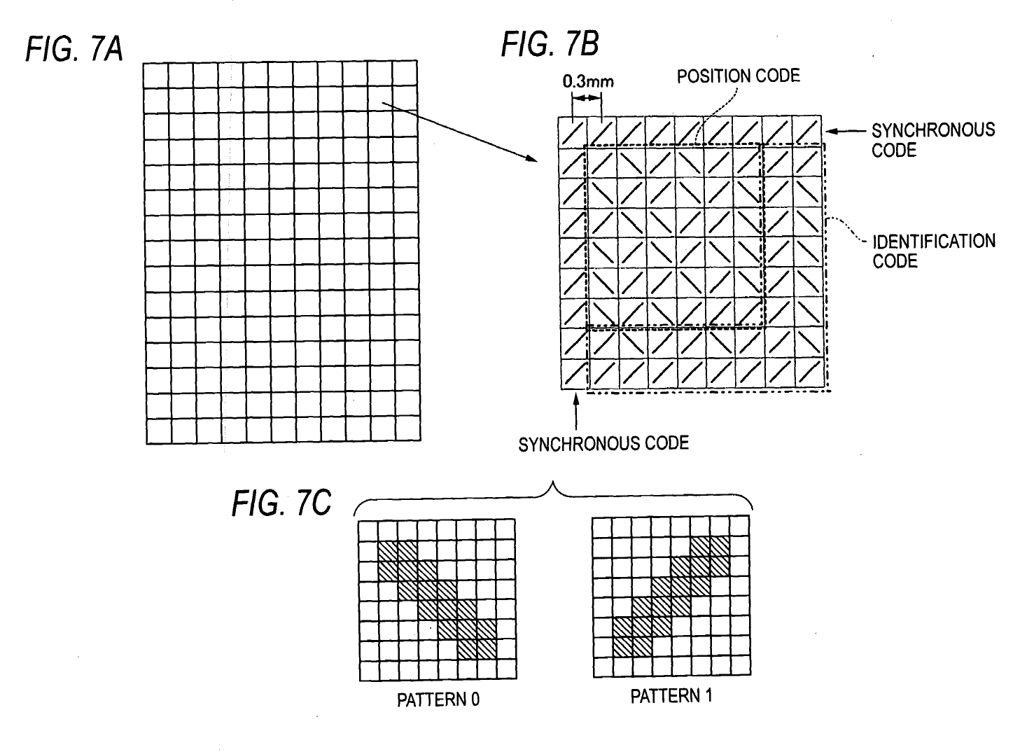

FIGS. 7A to 7C are views explaining two-dimensional code image which is generated by the code image generating unit 307 of the identification information managing server 300 and printed by the printer device 500a (invisible unit 10I) of the image forming apparatus 500. FIG. 7A shows the two-dimensional code image, which is formed and arranged by the invisible image, in a grid shape. FIG. 7B shows a unit of the two-dimensional code image. FIG. 7C is a view explaining oblique patterns such as a backslash “Y” and a slash “/”.

The two-dimensional code images shown in FIGS. 7A to 7C can be stably machine-read due to infrared irradiation and decoded for a long time and can become the invisible image which can record information with high density. In addition, the invisible image can be preferably provided on any area, regardless of an area in which the visible image is formed on the-surface of the medium for outputting the image. In the present embodiment, the invisible image is formed on entire surface of the medium in conformity with the size of the printed medium. In addition, it is more preferable that the invisible image can be recognized by a gloss difference when viewed with naked eye. However, the “entire surface” does not define all four edges of the sheet. In the electrophotographic device such as the printer device 500a, the edge of the sheet cannot be generally printed. Accordingly, the invisible image need not be printed on the edges.

The two-dimensional code pattern shown in FIG. 7B includes an area in which the position code representing the coordinate position on the medium is stored and an area in which the identification code for only specifying the printed medium or the electronic document is stored. The two-dimensional code pattern further includes an area in which a synchronous code is stored. As shown in FIG. 7A, a plurality of two-dimensional code patterns is arranged and the two-dimensional codes in which the other position information is stored are arranged on the entire surface of the medium in a grid shape in conformity with the size of the printed medium. That is, the plurality of two-dimensional code patterns is arranged on one surface of the medium as shown in FIG. 7B and has the position code, the identification code, and the synchronous code, respectively. In a plurality of position code areas, different position information is stored depending on the position. Meanwhile, in a plurality of identification code, areas, the same identification information is stored regardless of the position,

In FIG. 7B, the position codes are arranged in a rectangular area of 6 bits×6 bits. The respective bit values are formed by a plurality of fine line bit maps having different rotation angles and a bit value 0 and a bit value 1 are represented by the oblique patterns (pattern 0 and pattern 1) shown in FIG. 7C. Specially, the bit value 0 and the bit value 1 are represented using the backslash “V” and the slash “/” having different slopes. The oblique pattern is configured by a size of 8 pixels×8 pixels in 600 dot per inch (dpi). The backslash pattern (pattern 0) represents the bit value 0 and the slash pattern (pattern 1) represents the bit value 1. Accordingly, one bit (0 or 1) can be represented by one oblique pattern. By using the fine line bit map having two slopes, noise applied to the visible image is very low and the two-dimensional code pattern capable of digitalizing and embedding a mass of information with high density can be provided.

That is, total 36 bits of position information are stored in the position code area shown in FIG. 7B. Among 36 bits, 18 bits can be used for coding of an X coordinate and the rest of 18 bits can be used for coding of a Y coordinate. When the 18 bits are used for coding of every position, 2¹⁸ (about twenty-six hundred thousand) positions can be coded. When the oblique pattern is composed of 8 pixels×8 pixels (600 dpi) as shown in FIG. 7C, the size of the two-dimensional code (including the synchronous code) shown in FIG. 7B is about 3 mm (8 pixels×9 bits×0.0423 mm) vertically and horizontally, because one dot of 600 dpi is 0.0423 mm. When the twenty-six hundred thousand positions are coded at an interval of 3 mm, the coding can be performed by the length of about 786 m. All the 18 bits may be used for coding of the position or a redundancy bit for detecting or correcting error may be included when the detection error of the oblique pattern is likely to be generated.

The identification codes are arranged in a rectangular area of 2 bits×8 bits and 6 bits×2 bits. In the identification code area, total 28 bits of identification information can be stored. When all the 28 bits are used as the identification information, 228 (about 270 million) pieces of the identification information can be represented. Similar to the position code, the identification code may include a redundancy bit for detecting or correcting error in the 28 bits.

In the example shown in FIG. 7C, the angles of two oblique patterns are different from each other by 90 degrees. Alternatively, when an angle difference is set to 45 degrees, four oblique patterns can be configured. By this configuration, 2-bit information (0 to 3) can be represented by one oblique pattern. That is, by increasing the kind of the angle of the oblique pattern, the number of bits which can be represented can increase.

Although, in the example shown in FIG. 7C, the bit value is coded using the oblique pattern, the selectable pattern is not limited to the oblique pattern. For example, a coding method using ON/OFF of the dot or a direction in which the position of the dot is deviated from a reference position may be employed.

An imaging process using the printer device 500a shown in FIG. 4 will be described. For example, when the print instruction such as the image output instruction is received from the identification information managing server 300, the printer device 500a performs the imaging process. The printer device 500a temporarily stores digital image signals transmitted over the network 900 in the memory (not shown). Based on total six (Y, M, C, K, I, and R) digital image signals including five (Y, M, C, K, and I) stored digital image signals and a retroreflective digital image signal R generated by the printer device 500a, the toner image is formed.

That is, the imaging units 10 (10Y, 10M, 10C, 10K, 10I, and 10R) are driven based on image record signals obtained by an image process. Electrostatic latent images according to the image record signals are recorded onto the photosensitive drum 11 uniformly charged by the charger 12 using the exposing unit 13. In addition, the electrostatic latent images are developed by the developing unit 14 containing the toners corresponding to the recorded electrostatic latent images to form toner images. In the present embodiment, as described below, the retroreflective unit 10R forms the invisible image corresponding to the entire surface of the medium in conformity with the size of the printed medium (sheet P). Here, the “entire surface” does not define all four edges of the sheet, similar to the above-described invisible image.

The toner images formed on the photosensitive drum 11 are primarily transferred from the photosensitive drum 11 onto the surface of the intermediate transfer belt 20 at a primary transfer position, in which the photosensitive drum 11 and the intermediate transfer belt 20 are in contact with each other, by a primary transfer bias applied by the primary transfer roller 15. The toner images primarily transferred onto the intermediate transfer belt 20 overlap on the intermediate transfer belt 20 and is carried to a second transfer position by rotating the intermediate transfer belt 20.

Meanwhile, the sheet P is carried to the secondary transfer position of the secondary transfer unit 30 at a predetermined timing and is nipped between the intermediate transfer belt 20 (backup roller 23) and the secondary transfer roller 31. Then, the overlapped toner images carried on the intermediate transfer belt 20 is secondarily transferred onto the sheet P by a secondary transfer potential formed between the secondary transfer roller 31 and the backup roller 23.

Thereafter, the sheet P onto which the toner images are transferred is carried to the fixing unit 50 by the carrying belt 44 such that the toner images are fixed thereon. Meanwhile, after the secondary transfer, the remaining toner is removed from the intermediate transfer belt 20 by the belt cleaner 24.

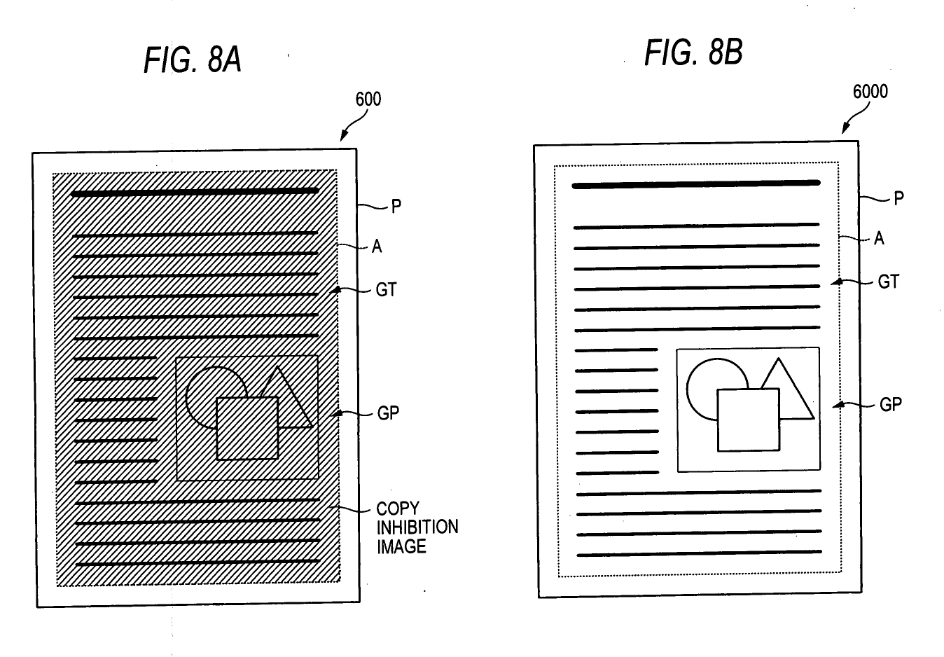

FIG. 8A shows an example of the printed material 600 output by the above-described imaging process, that is, the image formed on the sheet P.

In an image forming area A except the four edges of the sheet P, the visible image (document image) formed by the yellow unit 10Y, the magenta unit 10M, the cyan unit 10C, and the black unit 10K in a case of a fill-color image (only the black unit 10K in case of a monochromic image), that is, a text image GT based on the text data and a photo image GP based on the image data, is formed. In addition, the image forming area A corresponds to the “entire area” of the above-described medium. In addition, the invisible image is formed by the invisible imaging unit 10I over the entire surface of the image forming area A. In the present embodiment, the copy inhibition image (retroreflective image) is also formed by the retroreflective unit 10R over the entire surface of the image forming area A.

Meanwhile, FIG. 8B shows the printed material 6000 output using only the yellow unit 10Y, the magenta unit 10M, the cyan unit 10C, and the black unit 10K, which is compared with FIG. 8A. That is, FIG. 8B shows the image formed without using the invisible unit 10I or the retroreflective unit 10R. In this case, the visible image (document image) formed by the yellow unit 10Y, the magenta unit 10M, the cyan unit 10C, and the black unit 10K (only the black unit 10K in case of a monochromic image)), that is, a text image GT based on the text data and a photo image GP based on the image data, is formed in the image forming area A of the sheet P. In addition, the contents of the visible image are the same in FIGS. 8A and 8B.

Next, the read and copy of the printed material 600 or the printed material 6000 using the scanner device 500b will be described.

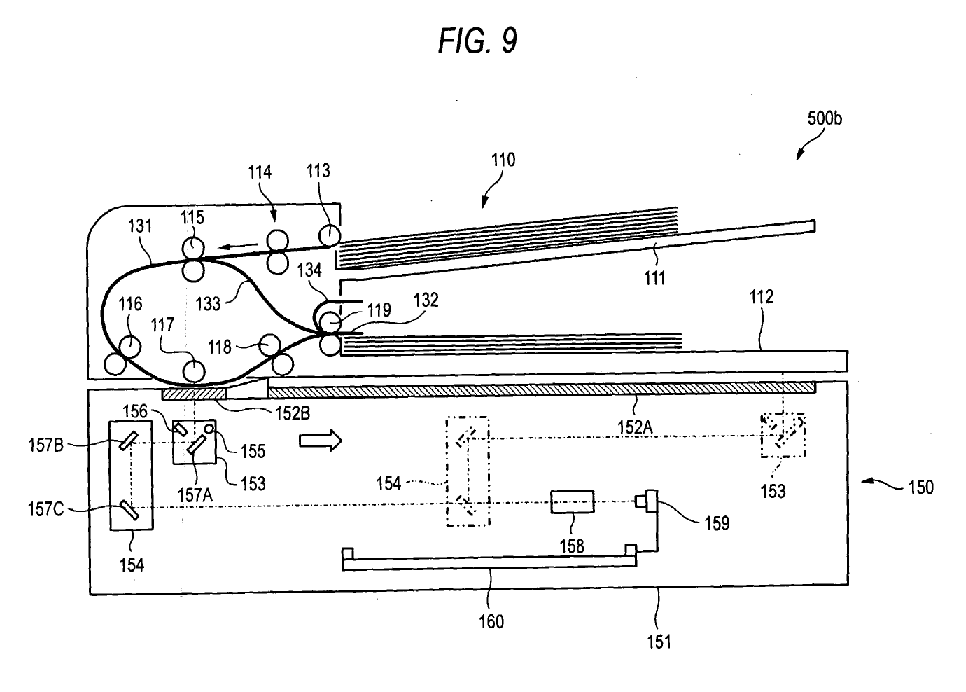

FIG. 9 is a view showing the scanner device 500b of the image forming apparatus 500. The scanner device 500b includes an original carrying device 110 for sequentially carrying the original from a plurality of loaded originals and a reading device 150 for reading the image by scanning.

The original carrying device 110 includes an original tray 111 for loading the plurality of originals and an ejection tray 112 for loading the read originals. The original carrying device 110 further includes a nudger roller 113 for ejecting and carrying the original from the original tray 111. A handle mechanism 114 for handling the sheet one sheet by one sheet by a feed roller and a retard roller is provided at a downstream side of an original carrying direction of the nudger roller 113. In a first carrying path 131 through which the original is carried, a flange roller 115, a registration roller 116, a platen roller 117, an out roller 118 are provided in that order from the upstream side of the original carrying direction. The flange roller 115 carries the original toward the downstream roller and forms a loop of the original. The registration roller 116 rotates, stops, and rotates in conformity with a timing and feeds the original while adjusting the registration with respect to the below-described original reading unit. The platen roller 117 assists the original which is being read by the reading device 150 to be carried. The out roller 118 carries the original read by the reading device 150 to the downstream side again.

In addition, a second carrying path 132 for guiding the original to the ejecting tray 112 is provided at the downstream side of the out roller 118 in the original carrying direction. In the second carrying path 132, an ejection roller 119 is provided.

In the scanner device 500b, a third carrying path 133 is provided between the outlet of the out roller 118 and the inlet of the flange roller 115 such that the images formed on the both surfaces of the original can be read by one process. In addition, the ejection roller 119 has a function for reversing and carrying the original to the third carrying path 133.

In addition, in the scanner device 500b, a fourth carrying path 134 for reversing and ejecting the original to the ejection tray 112 again when the both surfaces of the original are read is provided. The fourth carrying path 134 is provided at the upstream side of the second carrying path 132. In addition, the ejection roller 119 has a function for reversing and carrying the original to the fourth carrying path 134.

Meanwhile, as the reading unit, the reading device 150 openably and closably supports the original carrying device 110 by a device frame 151, and reads the image on the original carried by the original carrying device 110. The reading device 150 includes the device frame 151 for forming a case body, first platen glass 152A for loading the original having the image to be read in a stop state, and second platen glass 152B having an opening for reading the original carried by the original carrying device 110.

In addition, the reading device 150 includes a full-rate carriage 153 which stops under the second platen glass 152B or scans the first platen glass 152A and reads the image and a half-rate carriage 154 which supplies the light obtained by the full-rate carriage 153 to an imaging unit. The full-rate carriage 153 includes an illumination lamp 155 for irradiating light onto the original, a reflection mirror 156 for reflecting the light irradiated from the illumination lamp 155 toward the surface of the original, and a first mirror 157A for receiving light reflected from the original. In addition, the half-rate carriage 154 includes a second mirror 157B and a third mirror 157C for supplying the light obtained from the first mirror 157A to the imaging unit. The illumination lamp 155 has a light emitting wavelength from the visible area (400 nm to 800 nm) to the near infrared area (800 nm to 1000 nm). In addition, the reading device 150 has an imaging lens 158 and a charge coupled device (CCD) image sensor 159. The imaging lens 158 optically reduces an optical image obtained from the third mirror 157C. In addition, the CCD image sensor 159 converts the optical image formed by the imaging lens 158 into an electrical signal. That is, in the reading device 150, the image is formed on the CCD image sensor 159 using a so-called reduction optical system.

The reading device 150 further includes a control image processing unit 160. The control image processing unit 160 performs a predetermined process on the image data on the original input from the CCD image sensor 159. In additions the control image processing unit 160 controls the operations of the respective units in the reading operation of the scanner device 500b (original carrying device 110 and the reading device 150).

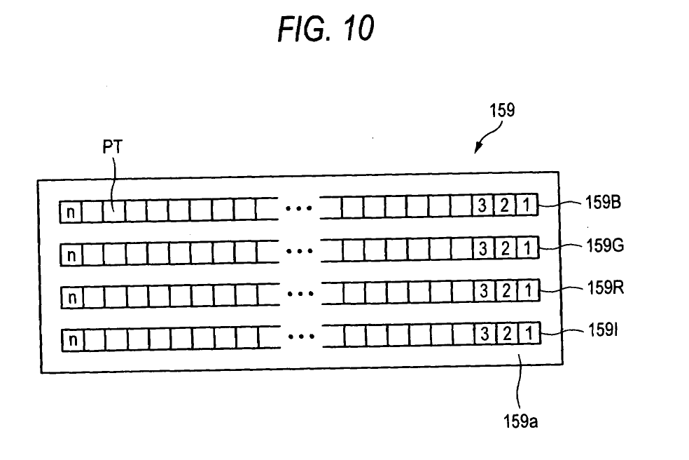

FIG. 10 is a view showing a schematic configuration of the CCD image sensor 159 provided in the reading device 150. The CCD image sensor 159 includes a substrate 159a and four line sensors 159B, 159G, 159R, and 159I which extend in parallel in a direction perpendicular to the original carrying direction. Each of the line sensors 159B, 159G, 159R, and 159I includes n photo transistors PT which are linearly arranged. The intervals among the line sensors 159B, 159G, 159R, and 159I are four lines.

The line sensors 159S, 159G, 159R, and 159I include respective color filters for transmitting different wavelength components, and function as blue line sensor, green line sensor, red line sensor, and infrared line sensor, respectively. The green line sensor 159G also functions as a black-white line sensor. In addition, the blue line sensor 159B, the green line sensor 159G, and the red line sensor 159R function as a visible image reading unit and the infrared line sensor 159I functions as an invisible image reading unit.

Next, the original reading operation using the scanner device 500b will be described. The scanner device 500b can read the original mounted on the first platen glass 152A (fixed original read) and the original carried by the original carrying device 110 (carried original read).

When the image on the original mounted on the first platen glass 152A is read, the full-rate carriage 153 and the half-rate carriage 154 move in a scan direction (arrow direction) at a ratio of 2:1. At this time, the light of the illumination lamp 155 of the full-rate carriage 153 is irradiated onto the read surface of the original. In addition, the light reflected from the original is sequentially reflected from the first mirror 157A, the second mirror 157B, and the third mirror 157C and guided to the imaging lens 158. The light guided to the imaging lens 158 forms an image on the CCD image sensor 159, that is, the light receiving surfaces of the blue line sensor 159B, the green line sensor 159G, the red line sensor 159R, and the infrared line sensor 159I. The blue line sensor 159B, the green line sensor 159G, the red line sensor 159R, and the infrared line sensor 159I are one-dimensional sensors and simultaneously process one line. The full-rate carriage 153 and the half-rate carriage 154 move in the line direction (sub scan direction) to read a next line of the original. This process is performed over the entire original to complete the read of one page of original.

Meanwhile, when the image on the original carried by the original carrying device 110 is read, the carried original is transmitted on the second platen glass 152B. At this time, the full-rate carriage 153 and the half-rate carriage 154 are in the stop state at a position denoted by a solid line shown in FIG. 9. In addition, the light reflected from one line of the original passing through the platen roller 117 of the original carrying device 110 is imaged on the imaging lens 158 through the first mirror 157A, the second mirror 157B, and the third mirror 157C and the image is read by the CCD image sensor 159, that is, the blue line sensor 159B, the green line sensor 159G, the red line sensor 159R, and the infrared line sensor 159I. In addition, the blue line sensor 159B, the green line sensor 159G, the red line sensor 159R, and the infrared line sensor 159I, all of which are the one-dimensional sensors, process one line in a main scan direction and reads a next line of the original carried by the original carrying device 110 in the main scan direction. The front end of the original reaches the reading position of the second platen glass 152B and the rear end of the original then passes through the reading position of the second platen glass 152B, thereby completing the read of one page of original in the sub scan direction.

Next, a relationship between the incident light irradiated onto the original by the illumination lamp 155 and the light reflected from the original in the scanner device 500b will be described.

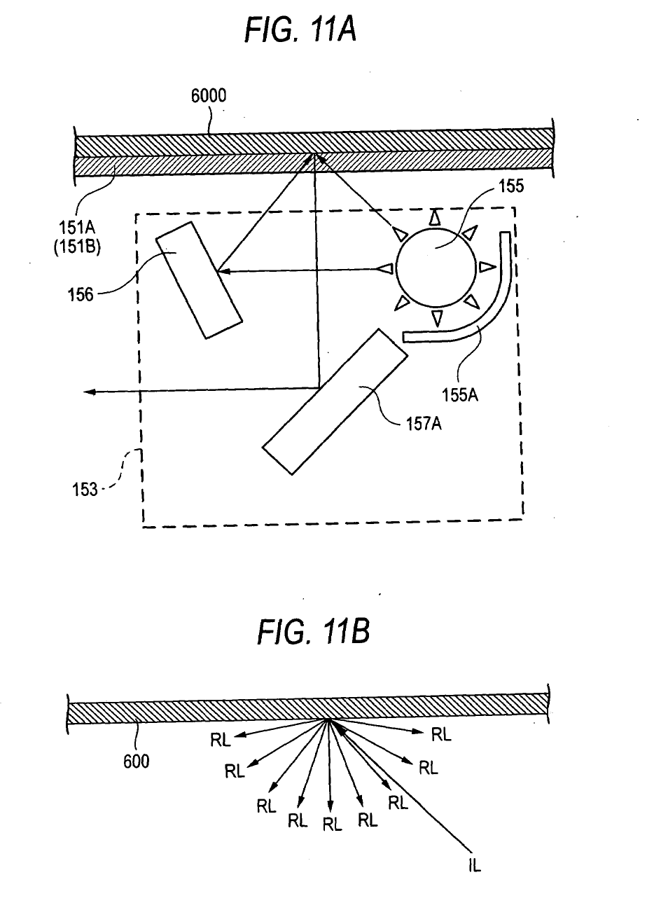

FIG. 11A schematically shows an optical path of the light when the printed material 6000 shown in FIG. 8B is the original. In addition, FIG. 11B shows a relationship between incident light IL and reflected light RL in the printed material 6000. As shown in FIG. 11A, an illumination mirror 155A for reflecting the light irradiated from the illumination lamp 155 toward the first platen glass 152A (second platen glass 152B) is provided on the rear surface of the illumination lamp 155.

As shown in FIG. 11A, the light irradiated from the illumination lamp 155 is directly irradiated to the printed material 6000 and indirectly irradiated to the printed material 6000 through the illumination mirror 155A or the reflection mirror 156.

The printed material 6000 has the visible image (specially, the text image GT and the photo image GP) formed in the image forming area A of the sheet P, as shown in FIG. 8B. The incident light irradiated to the printed material 6000 is diffusely reflected, as shown in FIG. 11B. In addition, as shown in FIG. 11A, a portion of the reflected light RL advances in a direction perpendicular to the surface of the original and enters into the CCD image sensor 159 (the blue line sensor 159B, the green line sensor 159G, the red line sensor 159R, and the infrared line sensor 159I; see FIG. 10) through the first mirror 157A. At this time, the amount of the reflected light RL varies depending on existence of the visible image at the read position and the light absorption in the concentration of the visible image, that is, the wavelength of the visible area.

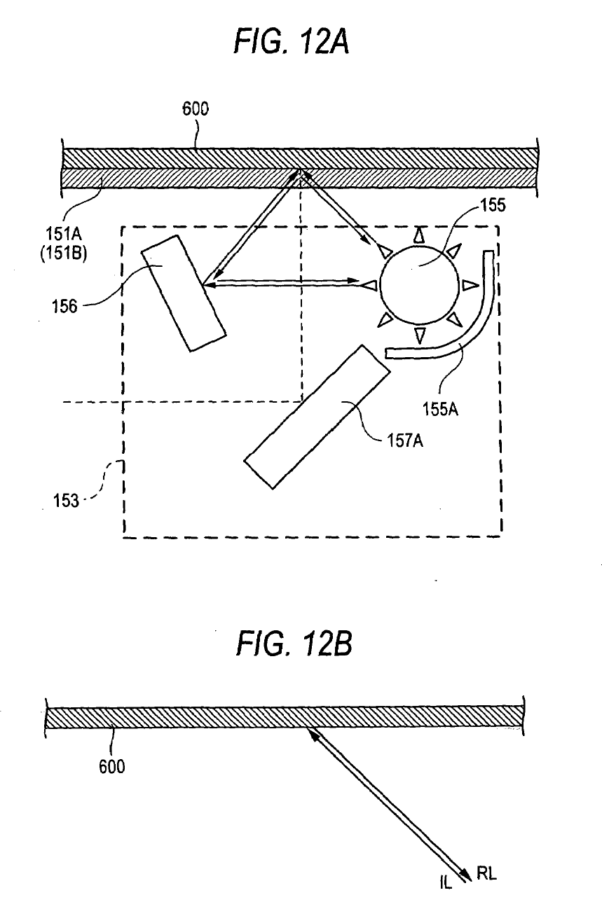

Meanwhile, FIG. 12A schematically shows an optical path of the light (visible light) when the printed material 600 shown in FIG. 8A is the original. In addition, FIG. 12B shows a relationship between incident light IL and reflected light RL of the light (visible light) in the printed material 600.

As shown in FIG. 12A, the visible light of the light irradiated from the illumination lamp 155 is directly irradiated to the printed material 600 and indirectly irradiated to the printed material 600 through the illumination mirror 155A or the reflection mirror 156.

As shown in FIG. 8A, the printed material 600 has the visible image formed in the image forming area A of the sheet P and the copy inhibition image (retroreflective image) formed on the entire surface of the image forming area A. To this end, the incident light IL of the visible light irradiated onto the printed material 600 is retroreflected without being diffusely reflected, as shown in FIG. 11B. That is, the incident light IL of the visible light becomes the reflected light RL reflected in the incident direction. In addition, the reflected light RL of the visible light from the printed material 600 returns to the illumination lamp 155 directly or through the reflection mirror 156. To this end, the reflected light RL of the visible light is not reflected in the direction perpendicular to the surface of the original. Accordingly, the reflected light RL of the visible light from the original does not enter into the CCD image sensor 159 through the first mirror 157A.

Although the printed material 600 is the original, the incident light IL of the infrared light of the light irradiated from the illumination lamp 155 onto the printed material 600 is diffusely reflected, as shown in FIG. 11B. In addition, as shown in FIG. 11A, a portion of the reflected light RL of the infrared light advances in the direction perpendicular to the surface of the original and enters into the CCD image sensor 159 (infrared line sensor 159I; see FIG. 10) through the first mirror. At this time, the amount of the reflected light RL of the infrared light varies depending on existence of the invisible image (code image) at the read position and the light absorption in the concentration of the invisible image, that is, the wavelength of the infrared area. This is because the retroreflective material R for forming the copy inhibition image (retroreflective image) has the retroreflective property with respect to the visible light and does not have the retroreflective property with respect to the infrared light, as described above.

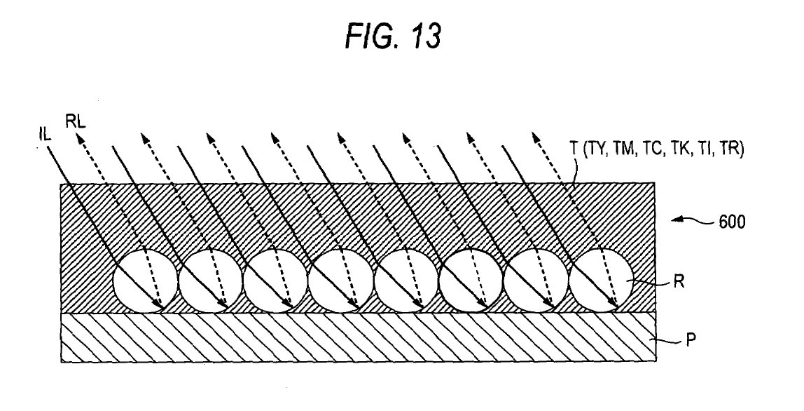

FIG. 13 is a view explaining retroreflection of the visible light in the printed material 600. As shown in FIG. 13, the toner images are fixed on the surface of the sheet P in the printed material 600 using the toners T (the yellow toner TY, the magenta toner TM, the cyan toner TC, the black toner TK, the invisible toner TI, and the retroreflective toner TR). In addition, the toner images on the sheet P includes the retroreflective materials R included in the retroreflective toner TR. FIG. 13 shows a state that the retroreflective materials R are arranged in a line. However, the retroreflective materials R randomly exist in the toner images composed of the fixed toner T.

The retroreflection is a special optical reflection mechanism and defined as a reflection phenomenon that the incident light returns in the incident direction as the reflected light. That is, the received light returns to the light source (illumination lamp 155 directly or through the reflection mirror 156 in the present embodiment), unlike the diffused reflection that the incident light is diffused in irregular directions or specular reflection that the incident angle of the incident light and the reflected angle of the reflected light are the same.

Then, a principle of the retroreflection will be described. The incident light IL (visible light in this example) entering into the retroreflective material R is refracted depending on a refractive index of the retroreflective material R on the surface thereof, specular-reflected from the inside of the retroreflective material R, refracted depending on the refractive index of the retroreflective material R on the surface thereof again, and emitted as the reflected light RL. An incident angle of the incident light IL of the retroreflective material R, an angle between the incident light IL and the reflected light RL in the retroreflective material R, that is, reflected angle, and an emitted angle of the emitted light RL from the retroreflective material R are the same. Accordingly, in the retroreflective material R, the incident light IL from all the directions always returns in the incident direction as the reflected light RL.

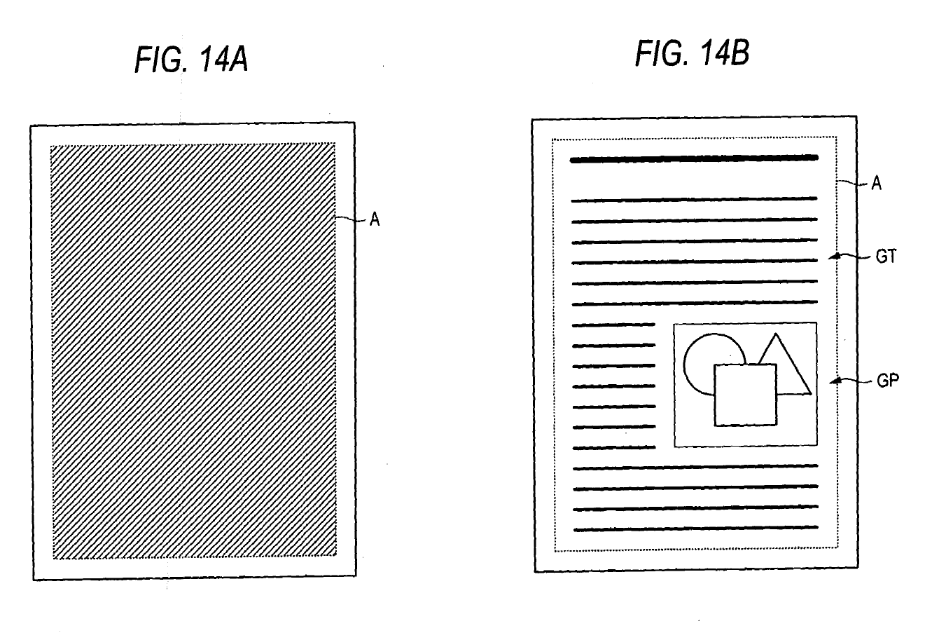

FIG. 14A shows the read data of the visible image obtained by reading the printed material 600 shown in FIG. 8A, that is, the original having the copy inhibition image (retroreflective image) by the scanner device 500b. FIG. 14B shows the read data of the visible image obtained by reading the printed material 6000 shown in FIG. 8B, that is, the original without the copy inhibition image (retroreflective image) by the scanner device 500b.

When the printed material 600 is read by the scanner device 500b, since the light irradiated from the illumination lamp 155 returns to the illumination lamp 155 by the retroreflection, as described with reference to FIGS. 12 and 13, the light does not enter into the CCD image sensor 159. As a result, as shown in FIG. 14A, the output of the entire surface of the image forming area A is black.

Meanwhile, when the printed material 6000 is read by the scanner device 500b, a portion of the light irradiated from the illumination lamp 155 enters into the CCD image sensor 159 through the illumination mirror 155A. As a result, as shown in FIG. 14B, the text image GT and the photo image GP in the image forming area A are reproduced.

As described above, in the present embodiment, when the visible image is formed using the black toner TK or the like, the copy inhibition image (retroreflective image) is formed on the entire surface of the image forming area A using the retroreflective toner TR including the retroreflective material R to obtain the printed material 600. To this end, it is impossible to substantially read the visible image on the printed material 600 by the scanner device 500b. Specially, by preventing the reflected light from the visible image from entering into the CCD image sensor 159 using the retroreflective property of the retroreflective material R, it is possible to output the black image on the entire surface as the read data of the scanner device 500b. Accordingly, it is possible to substantially inhibit the printed material 600 from being read or copied. Thus, the printed material 600 has a copy inhibition function.

Most scanners which are currently being used have an illumination system and a read system shown in FIG. 11 or FIG. 12. That is, the light is irradiated to the read position of the original in an inclined direction and the reflected light (scattered light) emitted in the direction perpendicular to the surface of the original is read by a sensor. To this end, by forming the image using the retroreflective toner TR including the retroreflective material R described in the present embodiment, the visible image on the printed material 600 is disabled to be read in the most scanners which are currently being used. That is, the image is automatically disabled to be read without providing a read inhibition means in the scanner.

In addition, even in the printed material 600 having the copy inhibition image including the retroreflective material R, the user can check the contents with the naked eye. When the user checks the contents of the printed material 600, the user views the printed material 600 at the front side thereof, because the incident direction and the reflection direction of the irradiated light in the sight line of the user are substantially equal to the vertical direction of the printed material 600.

The visible image of the printed material formed by the general toners Y, M, C, and K can be read by the scanner device 500b. Meanwhile, the visible image of the printed material 600 on which the copy inhibition image is formed using the retroreflective material R in addition to the general toners cannot be read by the-scanner device 500b. Although the visible image on the printed material 600 is read by the scanner device 500b, only the black image data or copy is obtained. However, there may be a need for copying and distributing the printed material 600 to predetermined members (for example, members related to a confidential matter). Accordingly, in the present embodiment, the original image data may be read from the read result of the invisible image (code image) formed together with the visible image or the copy inhibition image and output as the image data or the copied material 700.

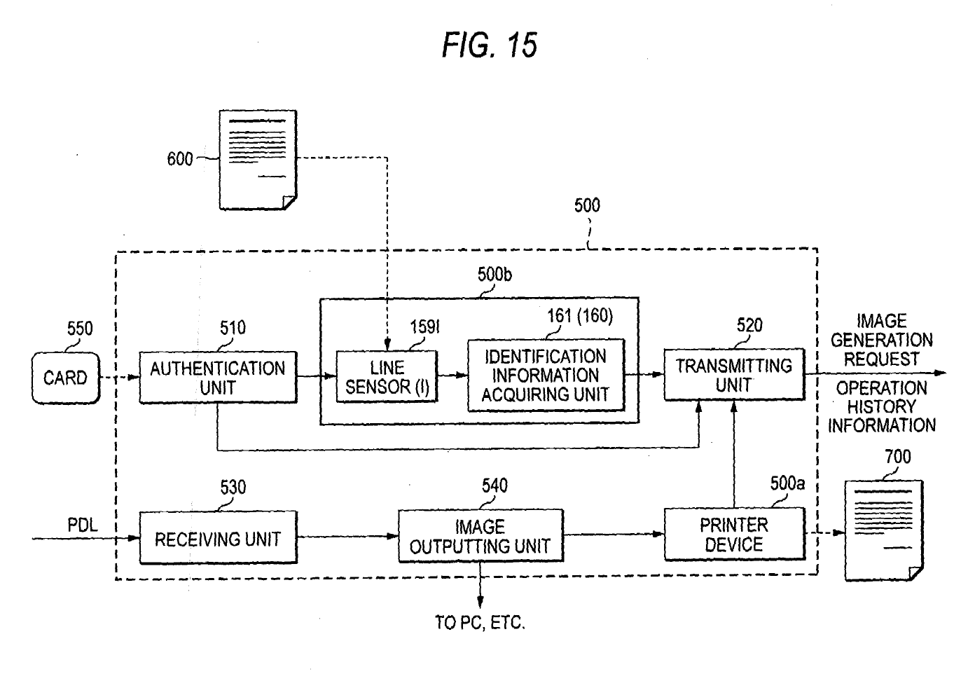

Next, a configuration of the image forming apparatus 500 related to operations from when scanning the printed material 600 to when printing out the contents of the visible image formed on the printed material 600 as the copied material 700 will be described with reference to FIG. 15.

The portions of the image forming apparatus 500 related to these operations include an authentication unit 510, a transmitting unit 520, a receiving unit 530, and an image outputting unit 540 in addition to the scanner device 500b for scanning the printed material 600 and the printer device 500a for outputting the copied material 700. The scanner device 500b further includes an identification information acquiring unit 161. The identification information acquiring unit 161 is provided in the control image processing unit 160 (see FIG. 9) of the scanner device 500b.

The authentication unit 510 receives an authentication card 550 composed of, for example, an IC card and acquires personal authentication data recorded in the received authentication card 550.

The identification information acquiring unit 161, which is provided in the scanner device 500b as the acquiring unit, acquires the identification information of the code image from the invisible image obtained by reading the printed material 600 by the infrared line sensor 159I.

The transmitting unit 520, which functions as the requesting unit, transmits an image generating request of the electronic document (visible image information) having the correspondence between the personal information acquired by the authentication unit 510 and the identification information acquired by the identification information acquiring unit 161, or operation history information according to the image generating request of the electronic document.

The receiving unit 530 receives the PDL, in which the output instruction of the image including the document image obtained by converting the electronic document corresponding to the printed material 600 scanned by the scanner device 500b into an image and the code image is described, from the identification information managing server 300 (see FIG. 1).

The image outputting unit 540 receives the image generated by the identification information managing server 300 through the receiving unit 530 and outputs the image to the printer device 500a. The image outputting unit 540 may be configured to output the image to, for example, an external personal computer, in addition to the printer device 500a, if necessary.

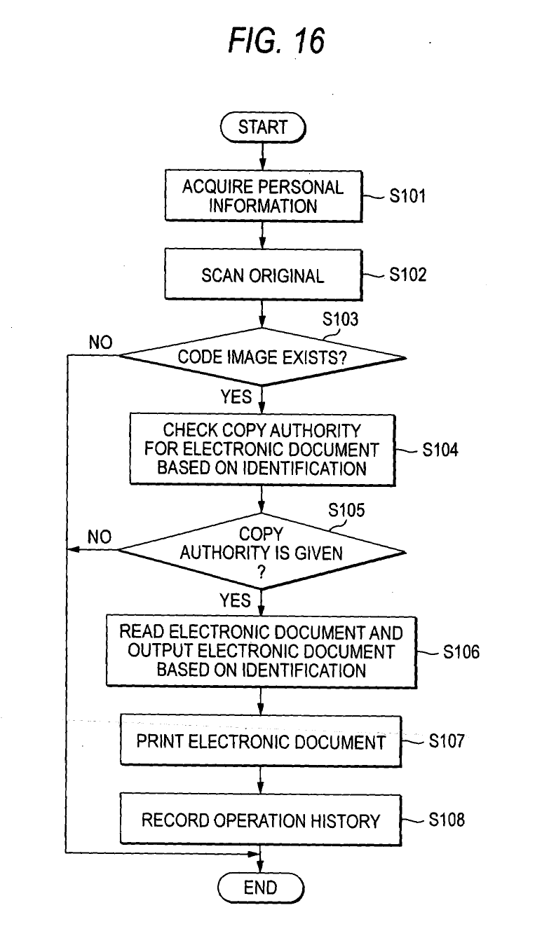

Next, an operation of copying the visible image on the printed material 600 to acquire the copied material 700 by exchanging the information between the image forming apparatus 500 and the identification information managing server 300 will be described with reference to FIG. 16.

When the user who wants to obtain the copied material 700 from the printed material 600 submits the authentication card 550, the authentication unit 510 acquires the personal information from the authentication card 550 (step 101).

When the personal information is acquired, the original which is the printed material 600 mounted on the first platen glass 152A or the printed material 600 set on the original tray 111 is scanned (step 102). At this time, the infrared line sensor 159I receives the reflected light of the light (infrared light) irradiated from the illumination lamp 155 onto the printed material 600. At this time, the blue image sensor 159B, the green image sensor 159G, and the red image sensor 159R also receive the reflected light of the light (visible light) irradiated from the illumination lamp 155 onto the printed material 600. However, since the copy inhibition image is formed on the printed material 600 as described above, the visible image cannot be read.

Next, the identification information acquiring unit 161 analyzes the invisible image read by the infrared line sensor 159I and determines whether the code image exists in the invisible image (step 103). When the code image exists in the invisible image, the transmitting unit 520 outputs the image generating request having the correspondence between the personal information acquired in the step 101 and the identification information acquired from the code information which is checked in the step 103 to the identification information managing server 300.

At this time, the identification information acquiring unit 161 performs the following process. The identification information acquiring unit 161 performs a slope correcting process and a noise removing process on the scanned image input from the infrared line sensor 159I to shape the scanned image. The identification information acquiring unit 161 detects the bit pattern (oblique pattern) such as the slash “/” and the backslash “¥” from the shaped scanned image and detects the synchronous code for positioning the two-dimensional code from the shaped scanned image. The identification information acquiring unit 161 detects the two-dimensional code with reference to the synchronous code position. In addition, the identification information acquiring unit 161 extracts and decodes information such as an error correcting code (ECC) from the two-dimensional code. The identification information acquiring unit 161 restores the original information from the decoded information and extracts the identification information from the restored code information. Thereafter, the identification information acquiring unit 161 transmits the extracted identification information to the identification information managing server 300 together with the personal information.

Next, the identification information managing server 300 receives the image generating request (the identification information and the personal information) and checks whether the copy authority for the electronic document exists (step 104) That is, it is checked whether the user corresponding to the personal information has the authority for performing the operation on the electronic document corresponding to the identification information. In addition, the identification information managing server 300 determines whether the user corresponding to the personal information has the copy authority for the electronic document corresponding to the identification information or not (step 105). When the user has the copy authority, the identification information managing server 300 converts the electronic document into the document image and the code information into the code image and outputs the synthesized image of the document image and the code image to the image forming apparatus 500 (step 106).

At this time, the identification information managing server 300 performs the following process. The receiving unit 301 of the identification information managing server 300 receives the image generating request (the identification information and the personal information) transmitted from the image forming apparatus 500. The received information is transmitted to the correspondence information managing unit 302 without alteration. The correspondence information managing unit 302 determines whether the electronic document corresponding to the identification information has copy permission for the user corresponding to the personal information with reference to the correspondence information DB 303. For example, as shown in FIG. 3, the copy authority of the electronic document corresponding to the identification information “00000001” is given to “AA” and “DD”, but is not given to “BB” and “CC”. That is, when the image generating request includes, for example, the identification information “00000001” and the personal information “AA”, it is determined that the copy authority is given in the step 105. In contrast, when the image generating request includes, for example, the identification information “00000001” and the personal information “BB”, it is determined that the copy authority is not given in the step 105.

When it is determined that the copy authority is given, the correspondence information managing unit 302 sends the storage position of the electronic document corresponding to the identification information to the transmitting unit 310 and the transmitting unit 310 transmits the request for acquiring the electronic document to be copied (printed) from the storage position to the document managing server 400.

Then, the document managing server 400 transmits the electronic document to be copied (printed) to the identification information managing server 300 and outputs the image including the document image and the code image to the image forming apparatus 500 through the transmitting unit 310 in the above-described sequence (step 106).

The image forming apparatus 500 receives the image and prints out the image, that is, the electronic document, using the printer device 500a (step 107) to obtain the copied material 700. Accordingly, the visible image formed on the copied material 700 is the same contents as the visible on the printed material 600. After printing, the image forming apparatus 500 outputs the operation history, that is, information as to who makes copies of which electronic document as the data having the correspondence between the personal information and the identification information to the identification information managing server 300. The identification information managing server 300 records the operation history (step 108). The operation history is preferably stored in the correspondence information DB 303 in correspondence with the identification information, and may be separately stored therein. When it is determined that the code image does not exist in the invisible image in the step 103 and when the user corresponding to the personal information does not possess the copy authority in the step 105, the process is immediately finished.

As described above, in the present embodiment, even in the printed material 600 on which the copy inhibition image (retroreflective image) is formed on the entire surface of the image forming area A using the retroreflective toner TR including the retroreflective material R, it is possible to obtain the copied material 700 having the same visible image as the printed material 600. Specially, the original image is printed out again using the code image (identification information) obtained by scanning the invisible image formed on the printed material 600 by the scanner device 500b, thereby obtaining the copied material 700. In the present embodiment, by storing the correspondence between the identification information of the printed material 600 and the personal information, it is possible to permit only the user possessing the copy authority for the printed material 600 to output the copied material 700. In addition, when the copied material 700 is output based on the printed material 600, the operation history is recorded and thus the copied material 700 can be managed. Accordingly, it is possible to obtain the copied material 700 of the printed material 600 while ensuring confidentiality of the printed material 600.

In the present embodiment, the invisible unit 10I, the retroreflective unit 10R, the yellow unit 10Y, the magenta unit 10M, the cyan unit 10C, and the black unit 10K are arranged in that order from the upstream side of the movement direction of the intermediate transfer belt 20. That is, when viewed from the sheet P, the image is formed such that the visible toner (yellow toner TY, magenta toner TM, cyan toner TC, and black toner TK), the retroreflective toner TR, the invisible toner TI are arranged on the sheet P in that order. This reason is as follows.

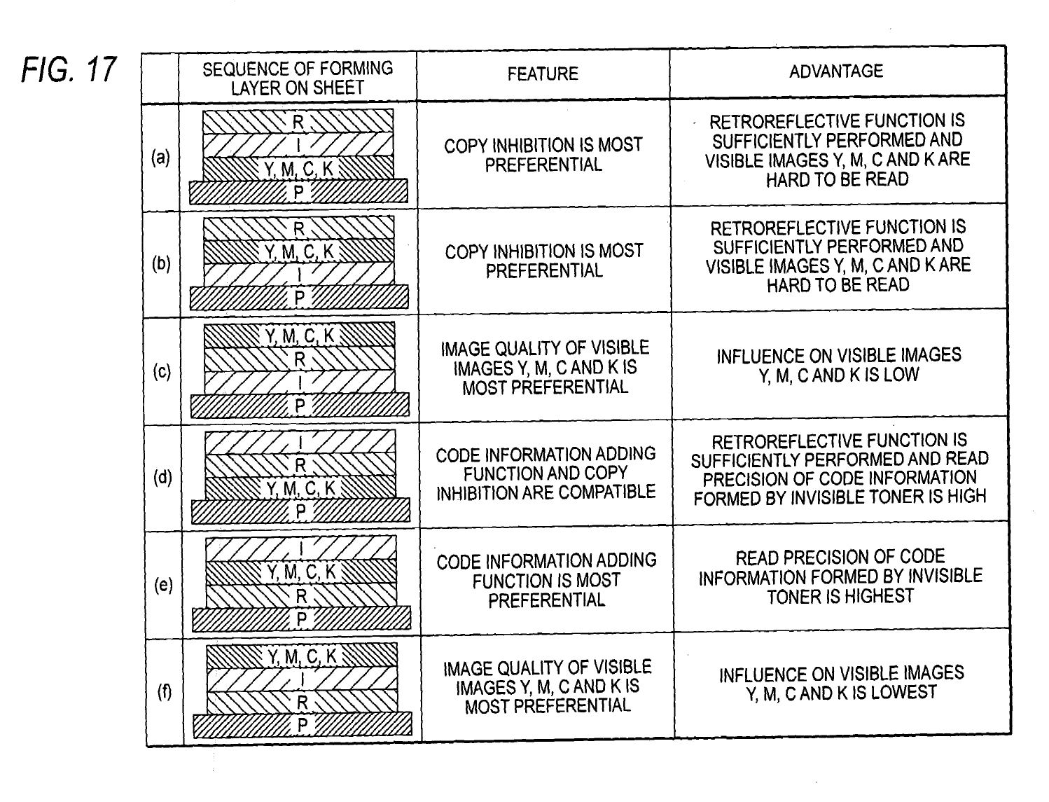

FIG. 17 is a table showing the sequence of forming a visible toner layer, an invisible toner layer, and a retroreflective toner layer on the sheet P, and features and advantages thereof.

In an example (a), the visible toner layer is formed on the sheet P, the invisible toner layer is formed on the visible toner layer, and the retroreflective toner layer is formed on the invisible toner layer (uppermost layer). In this case, since the retroreflective toner layer is formed on the uppermost layer, the retroreflective function of the retroreflective toner TR is sufficiently performed and the visible images Y, M, C, and K are hard to be read. Accordingly, when the copy inhibition is most preferential, this example is preferable.

In an example (b), the invisible toner layer is formed on the sheet P, the visible toner layer is formed on the invisible toner layer, and the retroreflective toner layer is formed on the visible toner layer (uppermost layer). Even in this case, since the retroreflective toner layer is formed on the uppermost layer, the retroreflective function of the retroreflective toner TR is sufficiently performed and the visible images Y, M, C, and K are hard to be read. Accordingly, when the copy inhibition is most preferential, this example is preferable.

In an example (c), the invisible toner layer is formed on the sheet P, the retroreflective toner layer is formed on the invisible toner layer, and the visible toner layer is formed on the retroreflective toner layer. In this case, since the visible toner layer is formed on the uppermost layer, the influence of the invisible toner TI or the retroreflective toner TR on the visible images Y, M, C, and K is reduced. Accordingly, when the image quality of the visible images is most preferential, this example is preferable.

In an example (d), the visible toner layer is formed on the sheet P, the retroreflective toner layer is formed on the visible toner layer, and the invisible toner layer is formed on the retroreflective toner layer. In this case, since the invisible toner layer is formed on the uppermost layer, it is possible to increase the read precision of the code information formed by the invisible toner. In addition, since the retroreflective toner layer is positioned between the invisible toner layer and the visible toner layer, it is possible to sufficiently perform the retroreflective function. Accordingly, when both a code information adding function and the copy inhibition are compatible, this example is preferable.

In an example (e), the retroreflective toner layer is formed on the sheet P, the visible toner layer is formed on the retroreflective toner layer, and the invisible toner layer is formed on the visible toner layer. In this case, since the invisible toner layer is formed on the uppermost layer and the visible toner layer is positioned between the invisible toner layer and the retroreflective toner layer, it is possible to most increase the read precision of the code information formed by the invisible toner. Accordingly, when the function of adding the code information is most preferential, this example is preferable.

In an example (f), the retroreflective toner layer is formed on the sheet P, the invisible toner layer is formed on the retroreflective toner layer, and the visible toner layer is formed on the invisible toner layer. In this case, since the visible toner layer is formed on the uppermost layer and the retroreflective toner layer is positioned on a lowermost, the influence of the retroreflective toner TR on the visible images Y, M, C, and K is reduced. Accordingly, when the image quality of the visible images is most preferential, this example is preferable.

That is, in the examples (a) to (f), in order to ensure both the code information read function and the copy inhibition function, the layer structure of the example (d) is most preferable. Accordingly, in the present embodiment, in order to realize such a layer structure, the imaging units 10 are arranged the above-described sequence.

Although, in the present embodiment, the copy inhibition image (retroreflective image) is formed on the entire surface of the image forming area A using the retroreflective toner TR including the retroreflective material, the present invention is not limited to this embodiment. For example, the copy inhibition image may be formed on only an area, in which an important matter is described, in the image forming area A.

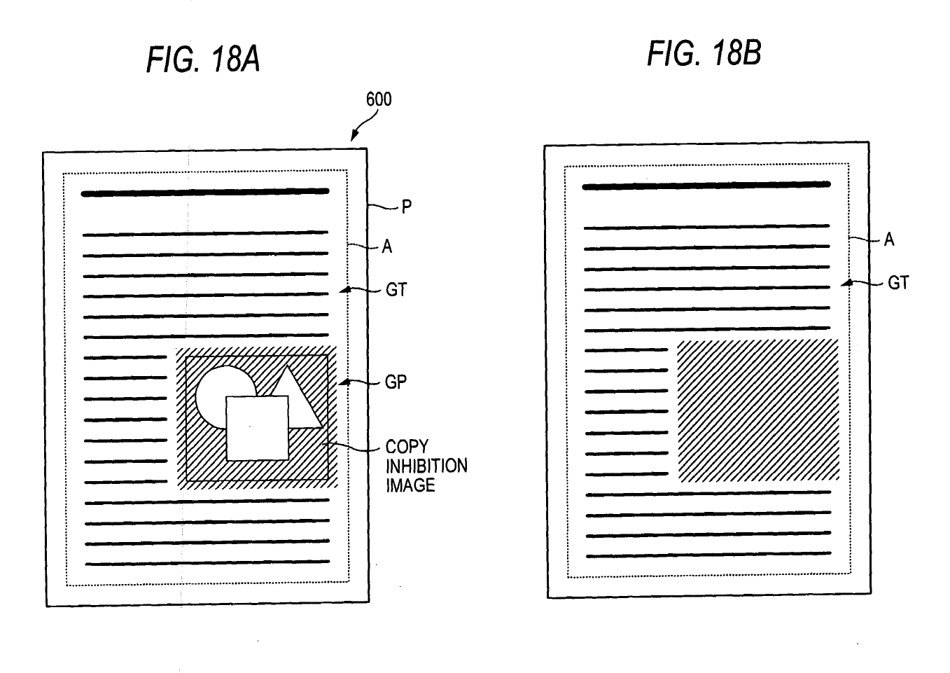

FIG. 18A shows an example of the printed material 600 on which the copy inhibition image is formed on only the area, in which the photo image GP is formed, in the image forming area A. FIG. 18B shows the read data of the visible image obtained by reading the printed material 600 shown in FIG. 18A using the scanner such as the scanner device 500b.

When the area in which the copy inhibition image is formed is selectively set, the output of the selected entire area (in this case, the area in which the photo image GP is formed) is black and the output of the other area has the general read image data. In addition, the area, in which the copy inhibition image is formed, can be, for example, set by the instruction of the terminal apparatus 200. In this case, the printer device 500a controls the imaging operation using the retroreflective unit 10R such that the copy inhibition image is formed on the desired area according to the instruction of the terminal apparatus 200.

### Second Embodiment

The present embodiment is different from the first embodiment in that the retroreflective material R is included in the toners T used in the yellow unit 10Y, the magenta unit 10M, the cyan unit 10C, and the black unit 10K for forming the visible image. In addition, in the present embodiment, the same elements as the first embodiment are denoted by the same reference numerals and thus their description will be omitted.

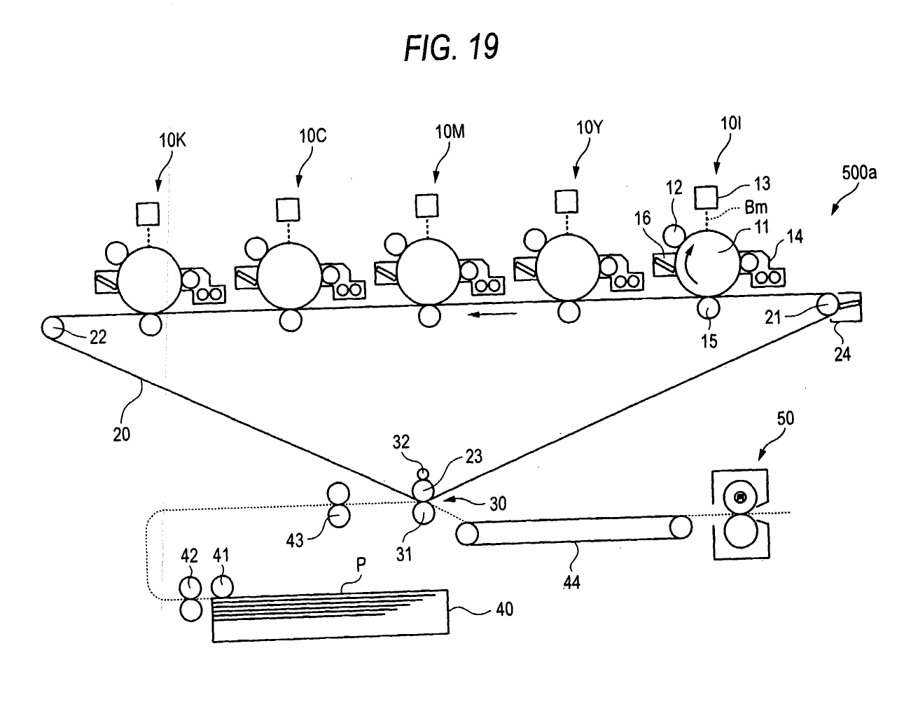

FIG. 19 is a view showing a configuration of the printer device 500a used in the present embodiment. In the present embodiment, unlike the first embodiment, the imaging units 10 of the image forming unit include the yellow unit 10Y, the magenta unit 10M, the cyan unit 10C, the black unit 10K, and the invisible unit 10I. That is, the retroreflective unit 10R is not provided. In the present embodiment, the retroreflective material R shown in FIG. 5C is included in the yellow toner TY, the magenta toner TM, the cyan toner TC, and the black toner TK of the image forming material used for the yellow unit 10Y, the magenta unit 10M, the cyan unit 10C, and the black unit 10K.

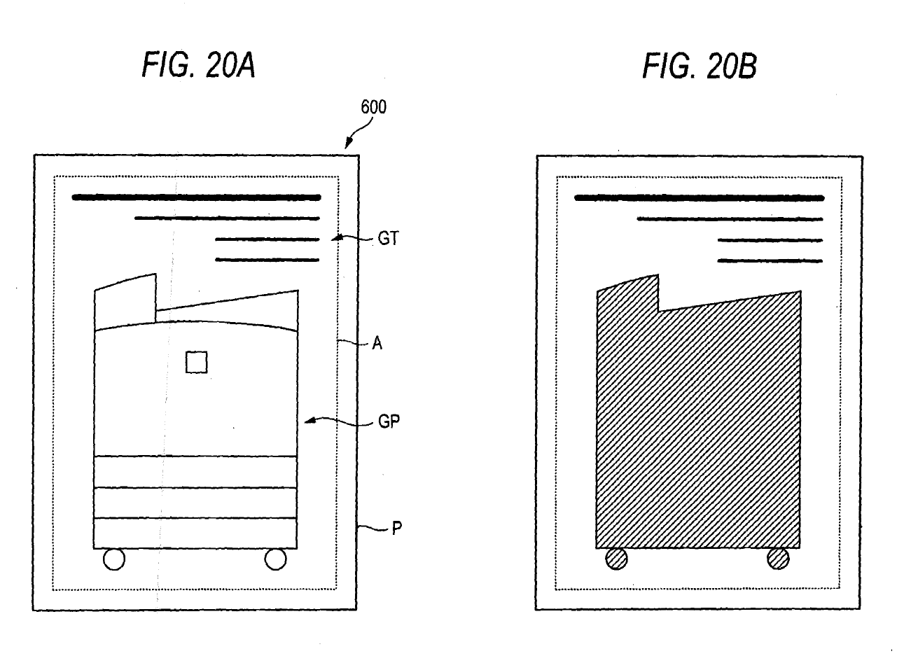

FIG. 20A shows the printed material 600 output using the printer device 500a in the present embodiment. FIG. 20B shows the read data of the visible image obtained by reading the printed material 600 shown in FIG. 20A by the scanner such as the scanner device 500b.

In the present embodiment, since the yellow unit 10Y, the magenta unit 10M, the cyan unit 10C, and the black unit 10K for forming the visible image include the retroreflective material R, the output of a portion in which the visible image is formed is black. Accordingly, for example, the photo image GP is black. To this end, similar to the first embodiment, it is possible to basically inhibit the printed material 600 to be copied.

In addition, when the code image using the invisible image is embedded at the time of preparing the printed material 600, it is possible to obtain the copied material 700 based on the read result of the printed material 600 by the same sequence as the first embodiment.

Although, in the first and second embodiments, the copy inhibition image (retroreflective image) including the retroreflective material R is formed on the sheet P using the printer device 500a, the present invention is not limited to these embodiments. For example, the retroreflective image including the retroreflective material R may be previously formed on the sheet P by coating. In this case, by forming the image using the printer which can form only the visible images (yellow, magenta, cyan, and black) which are widely used, it is possible to output the printed material 600 in which the visible image cannot be substantially read by the scanner.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a visible image forming unit that forms a visible image on a record material; and
a retroreflective image forming unit that forms a retroreflective image having a retroreflection property on the record material.

2. The image forming apparatus according to claim 1, wherein the visible image forming unit forms the visible image on the record material using a toner including a predetermined color material, and
wherein the retroreflective image forming unit forms the retroreflective image on the record material using a toner including a retroreflective material.

3. The image forming apparatus according to claim 1, wherein the visible image formed by the visible image forming unit and the retroreflective image formed by the retroreflective image forming unit overlap each other on the record material.

4. The image forming apparatus according to claim 1, wherein the retroreflective image forming unit forms the retroreflective image on an entire surface or a specific area of the record material, on which the visible image is formed by the visible image forming unit.

5. The image forming apparatus according to claim 1, wherein the retroreflective image has a high retroreflective property in a visible area and a low retroreflective property in a near infrared area.

6. The image forming apparatus according to claim 1, further comprising an invisible image forming unit that forms an invisible image on the record material.

7. The image forming apparatus according to claim 6, wherein the invisible image forming unit forms a code image including code information as the invisible image.

8. An image forming apparatus comprising:
a carrying unit that carries a record material; and
an image forming unit that forms an image on the record material carried by the carrying unit using an image forming material including a retroreflective material having a retroreflective property.

9. A printed material comprising:
a record material; and
an image including a visible image and a retroreflective image having a retroreflective property and formed on the record material.

10. The printed material according to claim 9, wherein the visible image and the retroreflective image overlap each other on the record material.

11. The printed material according to claim 9, wherein the image further includes an invisible image including code information.

12. An image reading apparatus comprising:
a reading unit that reads an image on an original;
an acquiring unit that acquires code information included in read image information; and
a requesting unit that requests information corresponding to the acquired code information to output.

13. The image reading apparatus according to claim 12, wherein the reading unit includes a visible image reading unit that reads a visible image formed on the original and an invisible image reading unit that reads an invisible image formed on the original, and
wherein the acquiring unit acquires the code information from information on the read invisible image.

14. The image reading apparatus according to claim 12, wherein the original read by the reading unit includes
a medium;
a visible image formed on the medium;
a retroreflective image formed on the medium together with the visible image and having a high retroreflective property in a visible area and a low retroreflective property in a near infrared area; and
an invisible image formed on the medium as a code image including the code information.
